(19) United States
(12) Patent Application Publication
(10) Pub. No.: US 2026/0244384 A1
(43) Pub. Date: Aug. 20, 2026

(54) INDUSTRIAL PRINTING SYSTEM, MANAGEMENT SERVER, AND PROCESSING MANAGEMENT METHOD FOR OPTIMALLY SCHEDULING JOBS BY MACHINE LEARNING

(71) Applicant: KYOCERA Document Solutions Inc., Osaka (JP)

(72) Inventor: Taku MATSUO, Los Angeles, CA (US)

(73) Assignee: KYOCERA Document Solutions Inc., Osaka (JP)

(21) Appl. No.: 19/056,390

(22) Filed: Feb. 18, 2025

(51) Int. Cl. G06F 3/12

(52) U.S. Cl. CPC G06F 3/1263; G06F 3/1211

(57) ABSTRACT

Provided is an industrial printing system that efficiently schedules jobs using AI and other methods. The scheduling management unit centrally manages the schedule setting for processing jobs on component apparatuses. The processing database stores characteristic data and processing result data for processed jobs, as well as processing performance data for the component apparatuses. The learning unit trains a model that optimally allocates the jobs to the component apparatuses based on the characteristic data, processing result data, and processing performance data stored in the processing database. The processing management unit allocates an unprocessed job to available schedule setting based on the model output results for the unprocessed job in accordance with instruction information that includes conditions to be prioritized, and it causes the corresponding component apparatus to process them.

### BACKGROUND

The present disclosure relates to an industrial printing system, management server, and processing management method for industrial printing (production printing) in particular.

In industrial printing, also known as production printing, which uses commercial (industrial) printing equipment, the components of the final product are produced in separate processes. For example, in the case of bookbinding, the cover, main body (color), main body (black and white), promotional materials, bands, and shipping envelopes are processed as separate jobs. Then, while combining each job in the middle of the process, the final product is finished as a book. Among the production printing systems, multiple jobs that perform the same processing are managed collectively by a management server, and a large number of printing jobs are distributed and printed in an even manner.

As a typical technology, an industrial printing system that performs distributed processing of production printing in a peer-to-peer manner is disclosed. This industrial printing system performs production printing and is equipped with multiple site servers. The multiple site servers perform distributed processing of printing jobs. Each site server is equipped with a storage unit, a processing judgment unit, and a processing management unit. The storage unit stores a capacity table that indicates the capacity that can be processed in the printing process and post-processing. The processing judgment unit determines, based on the capacity table stored in the storage unit, the other site server that can process the job from the multiple site servers. The processing management unit sets the processing schedule for the job by the other site servers that have been determined to be able to process it by the processing judgment unit, and sends the job to the other site servers according to the schedule setting and requests processing it.

### SUMMARY

An industrial printing system of the present disclosure is an industrial printing system for production printing having component apparatuses and a management server that manages jobs for the component apparatuses, including: a schedule management unit that centrally manages the schedule setting for processing jobs of component apparatuses; a processing database that stores characteristic data and processing result data of the processed jobs and processing performance data of the component apparatuses; a learning unit that trains a model for optimally allocating the jobs to the component apparatuses based on the characteristic data, the processing result data, and the processing performance data stored in the processing database; and a processing management unit that allocates an unprocessed job to the available space in the schedule setting based on an output result of the model for the unprocessed job in accordance with instruction information having a condition to be prioritized and causes corresponding component apparatus to process the unprocessed job.

An management server of the present disclosure is a management server that manages jobs for component apparatuses in an industrial printing system for production printing, including: a schedule management unit that centrally manages the schedule setting for processing jobs of the component apparatuses; a processing database that stores characteristic data and processing result data of the processed jobs and processing performance data of the component apparatuses; a learning unit that trains a model for optimally allocating the jobs to the component apparatuses based on the characteristic data, the processing result data, and the processing performance data stored in the processing database; and a processing management unit that allocates an unprocessed job to the available space in the schedule setting based on an output result of the model for the unprocessed job in accordance with instruction information having a condition to be prioritized and causes corresponding component apparatus to process the unprocessed job.

A processing management method of the present disclosure is a processing management method executed by a management server that manages jobs of component apparatuses in an industrial printing system for performing production printing, including the steps of: centrally managing the schedule setting for processing jobs of the component apparatuses; storing characteristic data and processing result data of the processed jobs and processing performance data of the component apparatuses; learning a model for optimally allocating the jobs to the component apparatuses based on the characteristic data, the processing result data, and the processing performance data that are stored; allocating an unprocessed job to the available space in the schedule setting based on an output result of the model for the unprocessed job in accordance with instruction information having a condition to be prioritized; and causing corresponding component apparatus to process the unprocessed job.

### BRIEF DESCRIPTION OF THE DRAWINGS

FIG. 1 is an example of a system configuration figure of an industrial printing system according to an embodiment of the present disclosure;

FIG. 2 is a block diagram showing the control configuration of the management server as shown in FIG. 1;

FIG. 3 is a block diagram showing the functional configuration of the management server as shown in FIG. 1;

FIG. 4 is a block diagram showing details of the processing DB as shown in FIG. 3;

FIG. 5 is a block diagram showing details of the job as shown in FIG. 3;

FIG. 6 is a flowchart of the job assignment process according to the embodiment of the present disclosure;

FIG. 7 is a conceptual diagram of the learning process as shown in FIG. 6; and

FIG. 8 is a conceptual diagram of the job assignment process as shown in FIG. 6.

### DETAILED DESCRIPTION

### Embodiment

### [Configuration of Industrial Printing System X]

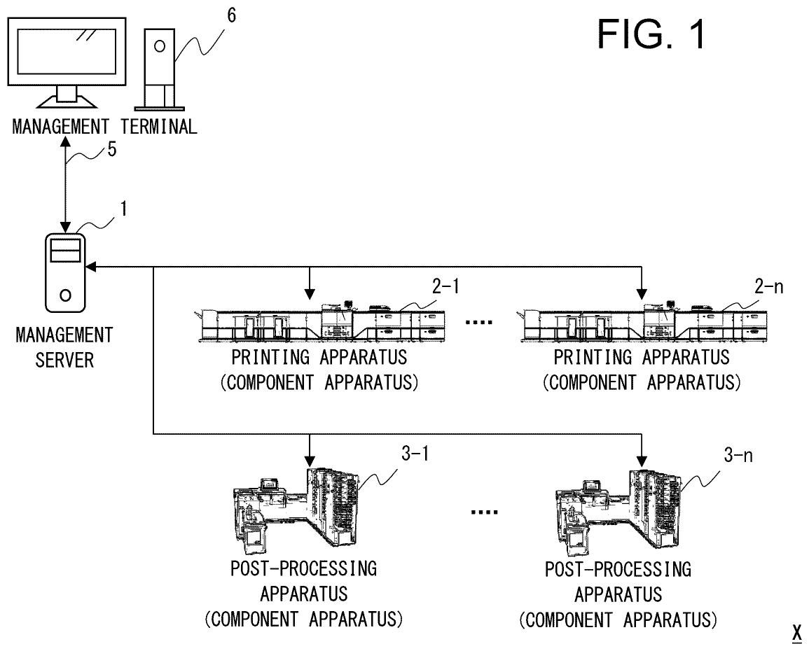

Firstly, as refer to FIG. 1, an example of the overall system configuration of the industrial printing system X according to the present embodiment is described.

The industrial printing system X of the present embodiment is a system that manages the workflow of the output from the printing process and post-processing process (hereinafter simply referred to as “printing”) in industrial printing (production printing.)

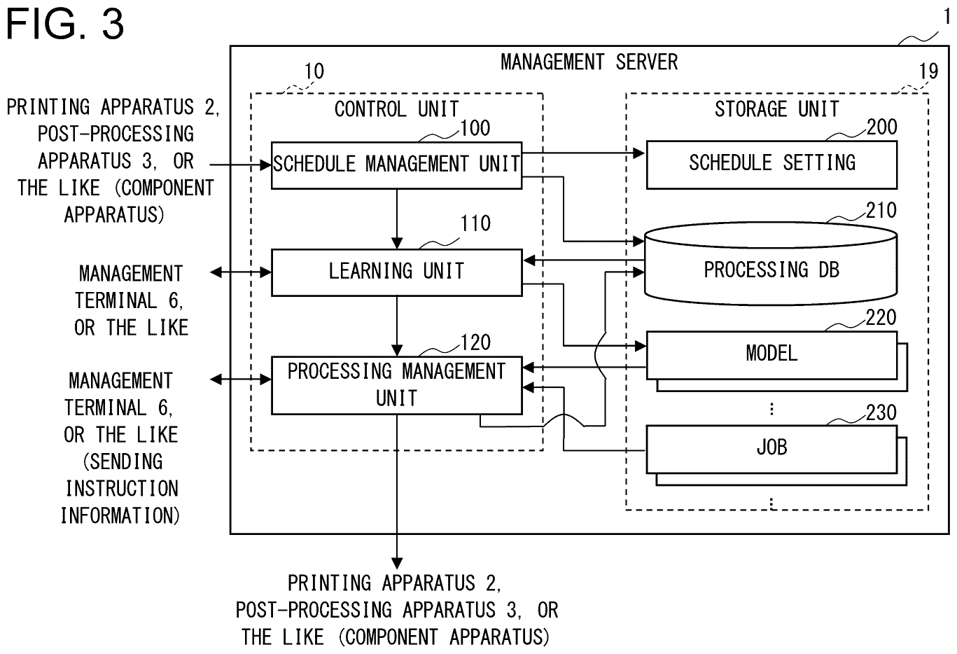

In the industrial printing system X according to the present embodiment, the final output of the printed book, or the like, is defined as an “order,” and each component of an order is defined as a job 230 (FIG. 3.)

The industrial printing system X is installed at locations such as printing companies and printing factories. In the present embodiment, the industrial printing system X has a management server 1 that controls a printing-related apparatus (hereinafter referred to as a “component apparatus”), which includes printing apparatuses 2-1 to 2-n and post-processing apparatuses 3-1 to 3-n. In addition, the management server 1 is connected with a management terminal 6 used by a user such as an administrator of industrial printing system X, or the like, via a network 5.

Hereinafter, when referring to one of the printing apparatuses 2-1 to 2-n, it is simply referred to as the printing apparatus 2. Similarly, when referring to one of the post-processing apparatuses 3-1 to 3-n, it is simply referred to as the post-processing apparatus 3.

The management server 1 is an information processing apparatus that manages and controls the component apparatuses and is a print controller or a digital front end (DFE). The management server 1 is configured with a personal computer (PC), server, dedicated machine, general-purpose machine, or the like. In the present embodiment, the management server 1 allocates the processing of job 230 to each component apparatus to be managed, for preforming execution according to the schedule.

In the present embodiment, the management server 1 sends and receives various instructions and information to the printing apparatus 2 and the post-processing apparatus 3 in production printing. In this way, the management server 1 manages the status of each apparatus and requests processing of the job 230.

In addition, in the present embodiment, the management server 1 manages the job 230 (FIG. 3) by executing dedicated print management (order output management) application software (hereinafter simply referred to as an “application”). This print management application (hereinafter referred to as the “dedicated application”) may be executed on a common platform. The common platform may also perform printing design creation, user management, tenant management, security management, notification services for maintenance, prepress processing management, storage management for each document, and management of printing apparatus 2, or the like. In addition, the management server 1 may have the function of a “fleet” server that manages the status of component apparatuses.

The printing apparatus 2 includes industrial printers, automated offset printing apparatuses, digital printers, and multi-functional peripherals (MFPs). Printing apparatus 2 is capable of performing printing processes such as small-lot printing or large-lot (multi-lot) offset printing. Each printing apparatus 2 in the present embodiment may have different sizes, paper qualities, color profiles, recordable ranges, or the like, of the recording paper used in the printing process.

The post-processing apparatus 3 is an apparatus that can perform post-printing processing (post-processing) of the printed paper, such as folding, collating, binding, trimming, bookbinding, and the like. The post-processing apparatus 3 in the present embodiment may also differ in the type and range of the processing that can be performed in the post-processing process.

The network 5 is a local area network (LAN), wireless LAN (Wi-Fi), wide area network (WAN) including Internet, mobile phone network, voice telephone network, industrial network, other dedicated line, or the like. The network 5 is capable of sending and receiving various commands and data with each apparatus. In addition, the network 5 may be configured as a VPN (Virtual Private Network), or the like.

The management terminal 6 is an information processing apparatus such as a PC, smartphone, tablet terminal, personal data assistant (PDA), dedicated terminal, or the like. The management terminal 6 is used by a user such as an administrator to control printing. In the present embodiment, the management terminal 6 executes the dedicated applications to perform scheduling settings and instructions, learning settings, cost confirmation, or the like.

In addition, the management terminal 6 can also execute applications that control the design and prepress of production printing. Further, the management terminal 6 may be connected with other terminal(s) for submitting data, design proofing terminals, or the like, for this design and prepress. Furthermore, the management terminal 6 may have functions for creating a job 230 (FIG. 3) and managing the processing requests for each apparatus by the management server 1. This enables the execution of functions such as acquiring a job 230, designing printing, submitting work for printing, managing prepress processing, checking progress status, requesting processing, and the like.

In addition, there may be a plurality of these apparatuses depending on the application and scale of printing, or the like. In addition, the other component apparatus managed by the management server 1 may be provided. The other component apparatus includes, for example, a terminal for submitting work for printing, terminal for design proofing, prepress apparatus, or the like.

In addition to the management server 1, a shipping management server that manages the shipping of orders sent after printing or post-processing is completed, and a server of an upstream system of the management server 1, or the like, may be provided. In addition, another general terminal used by a user may be connected with the network 5. This general terminal may include a so-called console.

Thus, the management server 1 can be accessed by users by using a management terminal 6 or general terminal, or the like, with a web browser, terminal, dedicated application, or the like. Therefore, the user can acquire the job 230, allocate the job 230, design printing, submit work, manage prepress processing, check progress, request processing, or the like.

### [Control Configuration of Management Server 1]

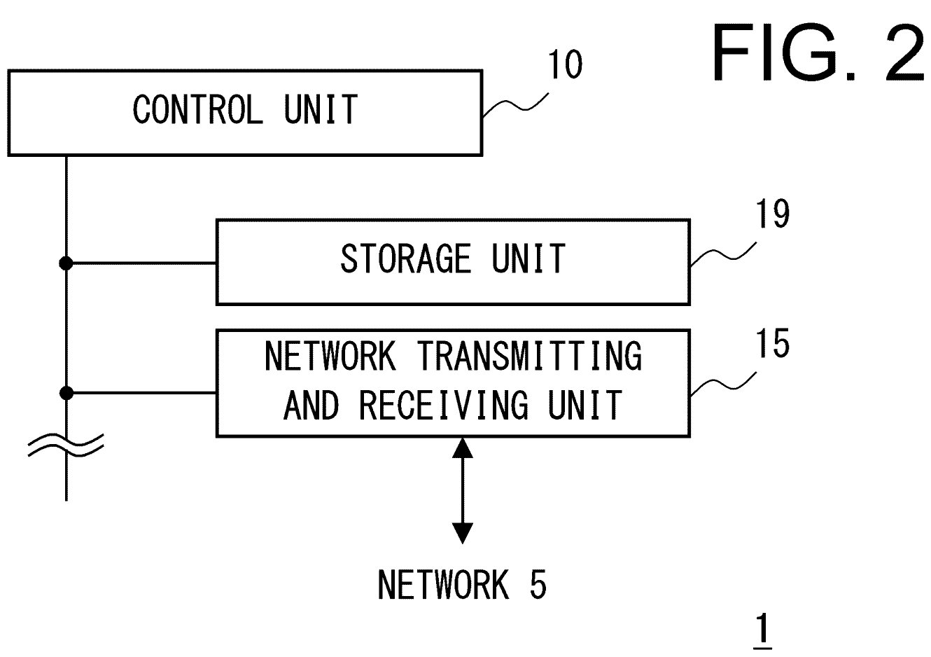

Next, as refer to FIG. 2, a control configuration of the management server 1 is explained.

The management server 1 includes a control unit 10, a network transmitting and receiving unit 15, and a storage unit 19. Each unit is connected with the control unit 10 and is controlled by the control unit 10.

The control unit 10 may be any processor or other controller. Examples include an information processing unit such as a general purpose processor (GPP), a central processing unit (CPU), a micro processing unit (MPU), a digital signal processor (DSP), a graphics processing unit (GPU), a neural processing unit (NPU), a tensor processing unit (TPU), an application specific integrated circuit (ASIC), or the like.

In the present embodiment, the control unit 10 is capable of accelerating matrix operations for artificial intelligence (AI), such as deep neural network (DNN), other type machine learning, and statistical calculations, or the like (hereinafter simply referred to as “AI, or the like”) by using the GPU, NPU, TPU, and the like. The control unit 10 is capable of performing high-speed calculations for this AI, or the like, including calculations for the generated model 220 (FIG. 3) and also for training (learning) the model 220 itself.

The control unit 10 is capable of operating as each of the functional blocks described later by reading out the control program stored in the ROM or HDD of the storage unit 19, expanding this control program in the RAM, and executing it. In addition, the control unit 10 controls the entire apparatus in accordance with the instruction information 360 input from the management terminal 6 or general terminal.

The network transmitting and receiving unit 15 is a network connection unit that includes a LAN board and wireless transmitter/receiver for connecting to the network 5. The network transmitting and receiving unit 15 transmits and receives data over data communication lines and transmits and receives voice signals over voice telephone lines.

The storage unit 19 is a non-transitory recording medium. The storage unit 19 includes semiconductor memories such as read only memory (ROM) and random access memory (RAM), magnetic storage such as hard disk drive (HDD), or the like. The ROM, such as flash memory or solid state drive, or the like, or HDD in the storage unit 19 stores the control program for controlling the operation of the management server 1. This control program includes the operating system (OS), middleware on the OS, services (daemons), various applications, database data, and the like. Among these, the various applications include the printing process management application as described above.

In the present embodiment, the storage unit 19 may store programs and data for processing raster-to-image (hereinafter referred to as “rasterization” or “RIP”) that converts vector (line drawing) image data into pixel image data (raster data) for printing. The programs and data for the rasterization processing include commercial libraries and fonts, or the like. In addition, the storage unit 19 also stores information on connected component apparatuses, control programs, or the like. Furthermore, the storage unit 19 may also store user account settings, other data, or the like, for the industrial printing system X.

In the management server 1, the control unit 10 may be integrally formed, such as a CPU with a GPU, a chip-on-module package, or a system on a chip (SOC). The control unit 10 may also have built-in RAM, ROM, flash memory, or the like.

### [Functional Composition of Management Server 1]

Here, as refer to FIGS. 3 to 5, the functional composition of management server 1 is explained.

The control unit 10 of management server 1 has a schedule management unit 100, a learning unit 110, and a processing management unit 120.

The storage unit 19 stores a schedule setting 200, a processing DB 210, model 220, and a job 230.

The schedule management unit 100 centrally manages the schedule setting 200 for processing the jobs 230 for the component apparatuses. In the present embodiment, the schedule management unit 100 manages the schedule for processing the printing apparatus 2 and post-processing apparatus 3 in the schedule setting 200.

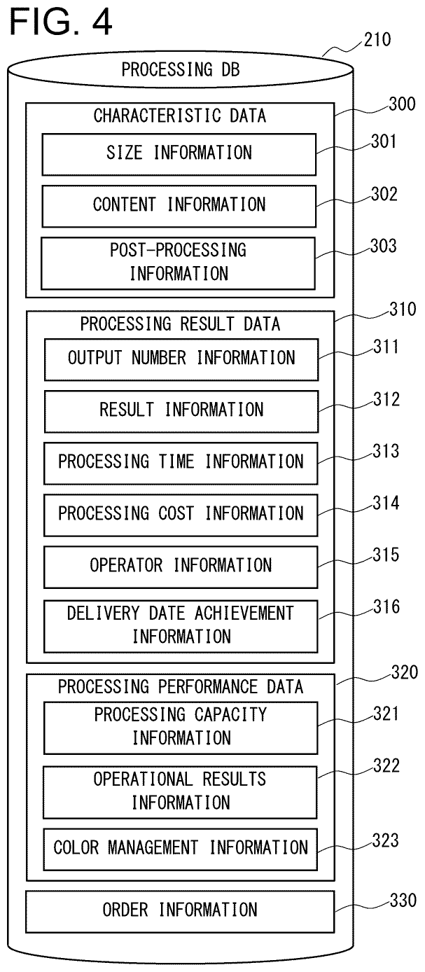

The learning unit 110 trains the model 220 that optimally allocates the jobs 230 to the component apparatuses based on characteristic data 300 (FIG. 4), processing result data 310, and processing performance data 320 stored in the processing DB 210.

Here, the learning unit 110 also trains the model 220 about scheduling optimization based on the instruction information 360 and the delivery date achievement information 316.

Furthermore, the learning unit 110 also trains the model 220 about the relationship between the order information 330 and the schedule setting 200.

The processing management unit 120 causes the learned (trained) model 220 to output information about unprocessed jobs 230 in accordance with the instruction information 360 that includes the conditions to be prioritized. The processing management unit 120 allocates the unprocessed jobs 230 to the available spaces in the schedule setting 200 based on the output results of the model 220. In this way, the processing management unit 120 causes the unprocessed jobs 230 to be processed by the corresponding component apparatus.

In the present embodiment, the processing management unit 120 uses the model 220 to output information on the possibility of handling sudden orders based on user instructions from the management terminal 6.

Further, the processing management unit 120 may manage the processing of the job 230 according to the settings of the dedicated application by sending the job 230 itself, the data processed by the job 230, and processing status and completion notifications to the management terminal 6.

The schedule setting 200 is setting information that indicates the schedule status for executing each job 230. The schedule setting 200 includes, as for each identification (ID) of component apparatus, the processing schedule (allocation) or availability of job 230, the processing status of job 230, operating status, shipping records, or the like, in chronological order. Among these, the shipping record is information about the physical shipping of the printed material after printing, and it may include information such as the time of completion of printing, shipping time, receipt time, and the like.

The processing DB 210 is a database that stores characteristic data 300 and processing result data 310 for the processed jobs 230 and the processing performance data 320 for component apparatuses.

The details of the processing DB 210 are described later.

The model 220 is data for models of AI, or the like. In the present embodiment, the model 220 has learned (trained) for the characteristics, processing results, and processing results of processed jobs 230 and component apparatuses.

Further, the model 220 also has learned (trained) the relationship between predictions and actual results in scheduling when the jobs 230 are allocateed to the available spaces in the schedule setting 200.

In addition, the model 220 also trains the relationship between the order information 330 and the schedule setting 200.

These models 220 may be single models, a composite model in which the models 220 are connected, or multiple independent models. In addition, in either case, an appropriate model such as convolution neural network (CNN), gaussian mixture model (GMM), Transformer, k-nearest neighbor (kNN), Bayesian network, kernel machine, decision tree, and various other machine learning and statistical models, and the like, can be selected and used.

The job 230 is data that summarizes various data used for printing in production printing. The job 230 may be described in, for example, job description format (JDF) and/or job messaging format (JMF).

The details of the job 230 are described later. (Details of Processing DB 210)

Then, as refer to FIG. 4, the details of the processing DB 210 are described.

In the present embodiment, the processing DB 210 includes characteristic data 300, processing result data 310, processing performance data 320, and order information 330.

The characteristic data 300 is detailed processing data that shows the characteristics of the job 230. In the present embodiment, the characteristic data 300 may be data that can analyze the characteristics of the job 230. More specifically, data regarding the characteristics of the job 230 is stored, which are a monochrome print job such as transactions that have a large number of pages but not a large data size, a color print job that have a small number of pages but a large data size and include photos using spot colors, and the like.

The processing result data 310 is data that summarizes various information about the processing results of the actual processing of the job 230. In the present embodiment, the processing result data 310 stores data that can be analyzed for each job 230 characteristic.

The processing performance data 320 is data on the processing results of printing and post-processing of the component apparatus. In the present embodiment, the processing performance data 320 stores data that can be analyzed for the processing capacity of the component apparatus for the job 230.

The details of the characteristic data 300, the processing result data 310, and the processing performance data 320 are described later.

The order information 330 is information about orders on the calendar. In the present embodiment, order information 330 may be information that can be analyzed to determine busy periods for orders, trends in sudden orders, or the like. In other words, the order information 330 may be information on the forecast and actual results of orders on the calendar. Furthermore, the order information 330 may include performance information when a sudden order has been processed.

Furthermore, in the present embodiment, the order information 330 may include information on a result of scheduling (hereinafter simply referred to as a “scheduling result.”) The scheduling result is data that indicates the results of scheduling by the processing management unit 120. For example, when a job 230 is allocateed based on the schedule setting 200, the scheduling result may be information indicating the results (score), such as the processing time, the average processing completion time of the allocated job 230, and the overall cost including the amount of consumables and expenses, and the like.

Here, it is explain the details of the characteristic data 300. In the present embodiment, the characteristic data 300 includes size information 301, content information 302, and post-processing information 303.

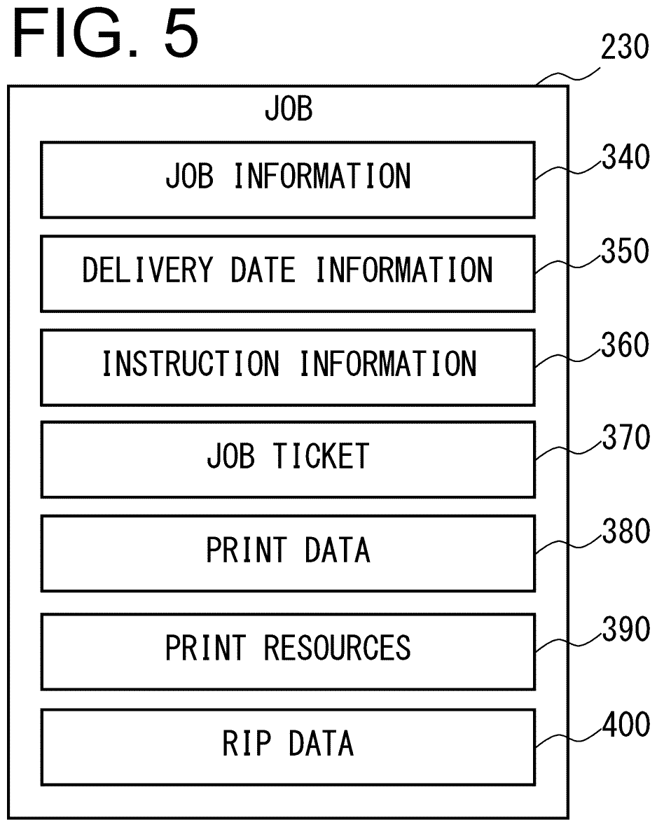

The size information 301 is information about the size characteristics of the job 230 calculated from the job information 340 (FIG. 5), the print data 380, and the print resources 390, or the like, in the job 230. For example, the size information 301 includes information such as data size, number of pages, paper size, and DPI (dots per inch).

The content information 302 is information about the content obtained from the job 230. For example, the content information 302 includes preflight information, profile information, font information, image data information, or the like.

The post-processing information 303 is information about the job 230 of post-processing and the post-processing specified by the job 230.

Then, it is explained the details of the processing result data 310.

In the present embodiment, the processing result data 310 includes output number information 311, result information 312, processing time information 313, and processing cost information 314.

The output number information 311 is information on the number of printed output sheets or copies when processing job 230.

The result information 312 is information indicating the results of printing and post-processing. Specifically, result information 312 includes information indicating whether a success, error, or waste occurred.

The processing time information 313 is information on the processing time taken for printing and/or post-processing of job 230.

The processing cost information 314 is information on the cost of ink used, paper used, or the like, in processing job 230.

The operator information 315 includes a log of the instruction information 360 and operator information about the job 230. The operator information includes the user who performed the scheduling work to allocate the job 230, the user who issued the execution instruction, or the like.

The delivery date achievement information 316 is information on the predicted and actual processing of the job 230. In other words, the delivery date achievement information 316 is information on the actual processing schedule compared with the planned processing schedule.

In the present embodiment, the delivery date achievement information 316 includes information such as the difference between the date and time set in the delivery date information 350 (FIG. 5) and the completion date and time for the job 230, how much time has been available, and the like. Furthermore, the delivery date information 316 includes information as to whether the job 230 was planned in advance, whether the job 230 was an unexpected order, or the like. This makes it possible to accumulate data that allows the degree of achievement of delivery completion for each characteristic of the job 230 to be analyzed.

Then, it is explain the details of the processing performance data 320. In the present embodiment, the processing performance data 320 includes processing capacity information 321, operation results information 322, and color management information 323.

The processing capacity information 321 is information on the number of processes performed for each characteristic for the job 230.

Further, the processing capacity information 321 also includes error information for the component apparatus. The error information includes performance information such as the error details, the number of times it occurred, the date and time it occurred, and the time required to recover from the error.

Furthermore, the processing capacity information 321 also includes work performance information for changing the set in the component apparatus. This work performance information for changing the set is information on the work for changing the set of the recording paper and other components.

In addition, the processing capacity information 321 also includes information on the actual performance of jobs 230 processed by batch processing, or the like, which processes the same processing in a batch.

The operation results information 322 is information on the operation performance of the component apparatus. In the present embodiment, the operation results information 322 accumulates data that enables the component apparatus operation rate to be analyzed from the operation performance against the schedule.

The operation results information 322 includes the performance information on the operation period and time of the component apparatus.

Further, the operation results information 322 includes performance information on the maintenance of the component apparatus, which includes the maintenance content and the information on the period, date, and time of the work.

Furthermore, the operation results information 322 includes the information on the non-operation time and the free time of the component apparatus.

The color management information 323 is information on the results of color management processing for component apparatuses. In the present embodiment, it includes information on color management work and color fluctuation status when scheduling and processing the job 230. This allows data to be accumulated that can be used to analyze how often color management should be performed and color correction should be performed.

In the present embodiment, the color management information 323 includes performance information on color management work. This information includes information on the content of the color management work, the date and time of the work, the elapsed time since the previous color management work, the number of jobs 230 processed, and the content of the processed jobs 230. The information on the content of the processed jobs 230 also includes information such as the number of printed pages, ink consumption, and the like.

The color management information 323 includes information on the status of color fluctuations against the threshold as the color fluctuation information.

In addition, in the present embodiment, the processing DB 210 may also include processing capacity information and status information for each component apparatus. This processing capacity information for the component apparatus may be information on the capacity that can be processed in rasterization, printing, and post-processing, processing time, and output speed (hereinafter referred to as “throughput.”) Further, the status information may be information on the set paper and consumables, operating status, maintenance, or the like.

In addition, in the present embodiment, the processing DB 210 may temporarily store user instruction via the management terminal 6. The user instruction includes the condition setting and threshold setting as shown below.

The condition setting is a setting of condition whether to prioritize the delivery date information 350 of the job 230 or to prioritize the cost when allocating the job 230. The condition setting may also be able to set a condition such as whether to apply, prioritize, or not apply the instruction information 360 of the job 230.

The user can set the condition of the condition setting by using the dedicated application, or the like.

The threshold setting is a setting of the conditions for starting execution of Job 230. In the present embodiment, the threshold setting includes a setting indicating the threshold condition for the completion processing time of Job 230. Specifically, the threshold setting is referenced when actually starting to allocate job 230. Specifically, the threshold setting can set threshold conditions such as the earliest time of the estimated completion time for each job 230 exceeding the threshold date and time first, or the latest time of the estimated completion time for each job 230 exceeding the threshold date and time first. This threshold date and time can be set by the user to a time period of several hours to several days. Then, the threshold setting may be referenced in the time of scheduling.

In the present embodiment, the processing DB 210 may also include estimate data. The estimate data may be data on the estimated cost of processing each job 230 when this job 230 is generated. For example, the estimate data may include estimates of the time required for printing and post-processing, estimates of the amount of consumables such as ink and paper, and estimates of other costs.

In addition, the processing DB 210 may also include alternative setting for the capabilities and setting states that can be substituted for the job 230 and component apparatuses. This alternative setting is set to indicate whether or not it is possible to substitute, for example, color mode and fonts. Furthermore, the alternative setting may also include settings such as the extent to which it is acceptable to substitute if it is possible to substitute. In addition, in the present embodiment, the alternative setting may be set by the user by using the dedicated application.

### (Details of Job 230)

Then, as refer to FIG. 5, the details of the job 230 are explained.

In this embodiment, data used in the job 230 is mainly described in terms of rasterization, printing, and post-processing.

The job 230 includes, for example, job information 340, delivery date information 350, instruction information 360, job ticket 370, print data 380, and print resources 390 (hereinafter, these are also referred to as “data contents.”) In addition, depending on the type of the job 230, the job 230 may include RIP data 400 as data contents.

The job information 340 is data that includes attributes specified in the printing process (hereinafter referred to as “specified attributes.”) As the specified attributes, the type of the job 230, the name of the job 230, the name of the project (order), the designation of the printing apparatus 2 or post-processing apparatus 3, the number of copies and whether or not collating is to be performed, whether or not recording is to be performed, the number of millimeters for trimming, the printing direction, the printing status, and the priority number, or the like, are set. Among these, the types of the job 230 include a job that performs rasterization processing (a rasterization job), a job that performs printing processing (a printing job), and a job that performs post-processing (a post-processing job).

The delivery date information 350 is information on the delivery date of job 230. The information on the delivery date can be set to one or more types of delivery time information, such as the delivery date and time, and the desired completion date and time. Among these, the due date and time is the date and time that must be completed for processing, which is specified by the user or upstream system. The desired completion date and time is the date and time that is desired for completion with respect to the due date and time. This desired completion date and time may correspond to the instruction information 360, which is explained below.

In addition, the due date and time information 350 may also include information on the estimated time for completion of processing output at the time of scheduling. Furthermore, in the present embodiment, the delivery date information 350 also stores data such as whether the data is already processed data or an unprocessed job 230.

The instruction information 360 is information about the user instruction that includes conditions to be prioritized for the job 230. Specifically, the instruction information 360 includes a priority setting for whether to prioritize the delivery date, the operating rate, or the number of processed jobs.

Among these, the instruction to prioritize the delivery date is an instruction to prioritize the delivery date in the delivery date information 350 and to perform processing as early as possible before the delivery date. The instruction to prioritize the operating rate is, for example, an instruction to maximize the operating rate within a specific period, such as the operating rate per day, and the like. The instruction to prioritize the number of processing jobs is, for example, an instruction that maximize the number of processing jobs 230 within a specific period, such as the number of processing jobs 230 per day, and the like.

Additionally, the instruction information 360 may include configuration information to be prioritized the cost of processing. Also, the instruction information 360 may include settings for priorities related to the output of the job 230, such as the type of component apparatus, paper type, and post-processing type at the time of output of the job 230. In addition, in the present embodiment, the instruction information 360 may also include reservation information for specifying the printing apparatus 2 or the post-processing apparatus 3.

The job ticket 370 is setting data that includes print instruction attributes for requesting the job 230. As print instruction attributes, the job ticket 370 includes lower-level setting in the workflow, which is the order settings. Also, the lower-level setting includes settings required in the printing process and post-processing, such as color mode specifications, imposition specifications, paper specifications, and binding specifications, and the like.

The job ticket 370 may also be described in JDF and/or JMF.

The print data 380 is data of a print manuscript whose design is set according to an order. The print data 380 may be, for example, electronic document data such as portable document format (PDF), post script (PS) data, other vector data, data in a format for submitting a manuscript, other raster image data, or the like.

The printing resources 390 are various resource information necessary for printing instructions such as color mode and fonts. These various resources may be referenced by model 220.

Other resource data necessary for printing may also be included in these print resources 390.

The RIP data 400 is data such as PDF that includes image data that has been rasterized based on the job ticket 370. This image data may be, for example, TIFF or other bitmap data. In addition, the image data may be lossless or lossy compressed.

In addition, the job 230 may include schedule change information, processing change record information when actually processed, and other information.

Here, the control unit 10 of the management server 1 is made to function as the schedule management unit 100, the learning unit 110, and the processing management unit 120 by executing the control program stored in the storage unit 19. In addition, the above-mentioned parts of the management server 1 become hardware resources that execute the processing management method of the present disclosure.

In addition, some or any combination of the above-mentioned functional components may be configured in hardware or circuitry by using ICs, programmable logic, FPGAs (Field-Programmable Gate Arrays), or the like.

### [Job Assignment Process by Management Server 1]

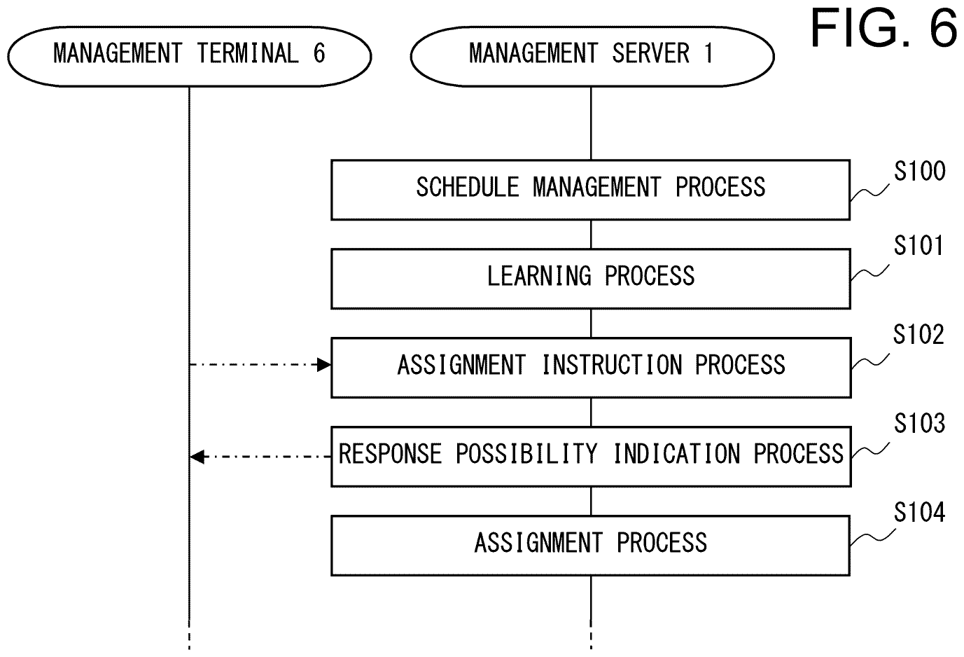

Next, as refer to FIGS. 6 to 8, it is explain a job assignment process performed by the management server 1 in accordance with the embodiments of the present disclosure.

In the job assignment process of the present embodiment, the schedule setting 200 for processing the job 230 of the component apparatus is centrally managed. Thus, the characteristic data 300 and processing result data 310 of the processed jobs 230 and the processing performance data 320 of the component apparatus are stored. Then, based on the characteristic data 300, processing result data 310, and processing performance data 320 stored in the processing database, the model 220 that optimally allocates the jobs 230 to component apparatuses is learned (trained.) Thereafter, according to the instruction information 360 that includes the condition to be prioritized, based on the output results of the model 220 for the unprocessed jobs 230, the unprocessed job 230 is allocated to the available space in the schedule setting 200 and processed by the corresponding component apparatus.

In the job assignment process of the present embodiment, the control unit 10 of the management server 1 mainly executes the program stored in the storage unit 19 in cooperation with each unit by using hardware resources.

With reference to the flowchart in FIG. 6, the details of the job assignment process are explained below, step by step.

### (Step S100)

Firstly, the schedule management unit 100 performs schedule management process.

The schedule management unit 100 centrally manages the schedule setting 200 for processing jobs 230 of component apparatuses.

In the present embodiment, the printing apparatus 2 and post-processing apparatus 3 (component apparatuses) managed and connected to the management server 1 share the schedule setting 200 for processing jobs 230 throughout the industrial printing system X. For this reason, the schedule management unit 100 connects with each component apparatus and ascertains the processing status and completion status of the job 230. Then, the schedule management unit 100 reflects these status information in the schedule setting 200 and updated in real time. This enables the schedule management unit 100 to centrally manage the available schedules of each component apparatus in the schedule setting 200.

Further, the schedule management unit 100 can also acquire information on processing capacity and status from each component apparatus as appropriate and set it in the schedule setting 200.

Then, the schedule management unit 100 sets the due date information 350 for the job 230 after processing to indicate that it has been processed, and it stores this job 230 itself (history information), the allocated component apparatus, and the various information about availability of the schedule in the processing DB 210.

### (Step S101)

Then, the learning unit 110 performs the learning process.

The learning unit 110 refers to the processing DB 210 as training data for the AI model 220, and it performs learning (training) of the model 220 based on the characteristic data 300 of the job 230, the processing result data 310 of the job 230, the processing performance data 320 of the component apparatus, and the order information 330.

The learning unit 110 can use the most suitable learning method for each model 220 as various machine learning (ML) methods. For example, it is possible to use supervised learning methods such as BP (backpropagation) and EM algorithms, unsupervised learning methods such as clustering, and reinforcement learning.

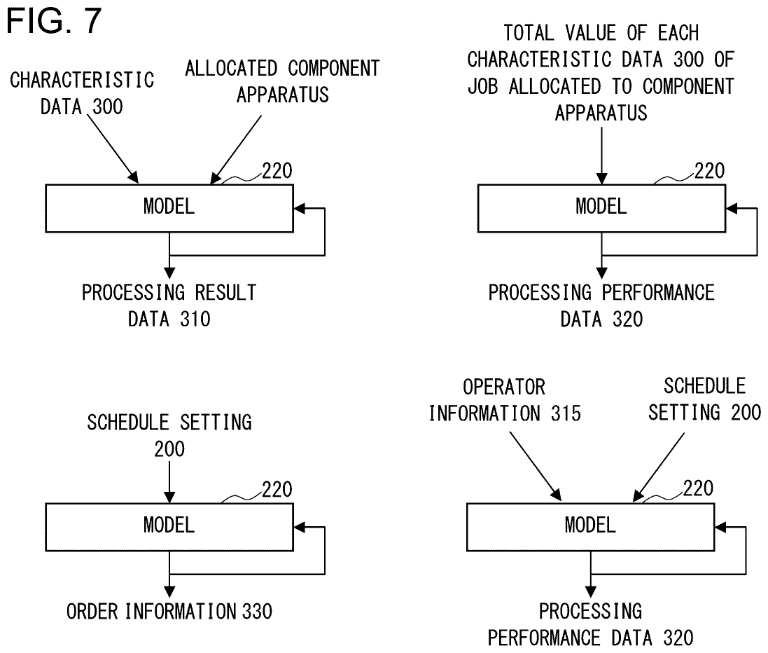

With referring to FIG. 7, a specific example of the learning process is explained.

The learning unit 110 inputs the characteristic data 300 and the specification of the allocated component apparatus for each processed job 230, and it trains a model 220 such that the information of each of the processed result data 310 is similarly output by using this characteristic data 300. As a result, the learning unit 110 trains the model 220 of the relationship between the job 230 and the component apparatus. As a result, it is possible to learn the model 220 that allocates jobs 230 to the most suitable component apparatus.

In addition, the learning unit 110 inputs the total of the characteristic data 300 of all jobs 230 allocated to each processed component apparatus, and it trains the model 220 so that each information in the processing result data 320 is output in the same manner as the actual value.

Furthermore, the learning unit 110 inputs the schedule setting 200 and trains a model 220 such that the busy periods for orders or trends in sudden orders are output in the same way as the order information 330. As a result, it is possible to learn the model 220 that shows the relationship between the schedule setting 200 and the order information 330.

Here, the learning unit 110 also trains scheduling optimization based on the instruction information 360 and the delivery date achievement information 316. The learning unit 110 outputs, as a score, availability information of the schedule setting 200 for the output of each of the learned models 220 when each of the processed jobs 230 is allocated in various combinations. The learning unit 110 trains the model 220 to provide the optimal combination based on the score.

Here, for each information to be output, the learning unit 110 may train each individual model 220, or it may train an integrated model 220. Note that each value input may be normalized as appropriate, or it may be convolved as appropriate for the input of the model 220.

Furthermore, the learning unit 110 may generate a model 220 that combines the processing capacity and state of the component apparatus.

Furthermore, the learning unit 110 can also present the state of the trained model 220 to the user via the dedicated application's graphical user interface (GUI) on the management terminal 6.

### (Step S102)

Then, the processing management unit 120 performs the allocation instruction process.

The processing management unit 120 acquires an unprocessed job 230 from the management terminal 6, the upstream base management system of the industrial printing system X, the other user terminal, the prepress apparatus, or the like, and it stores them in the storage unit 19, sequentially. The job 230 may be created by the management terminal 6 for a manuscript submitted by the submission terminal. Further, when the job 230 is acquired, the schedule management unit 100 may set the delivery date information 350 of the job 230 to be an unprocessed job 230.

Here, the processing management unit 120 acquires the instructions for allocating job 230 by using the dedicated application GUI on the management terminal 6. At this time, the processing management unit 120 acquires instruction for which of the delivery date, operating rate, and number of processed jobs 230 is to be prioritized and sets this as instruction information 360 for the unprocessed job 230.

Furthermore, the user can also input information such as the characteristics of the unprocessed jobs 230, the delivery date of the order, the priority information, and information on the component apparatus to be processed, or the like, by using the GUI. The processing management unit 120 acquires this information and sets it in the processing DB 210 and the job 230.

### (Step S103)

Then, the processing management unit 120 performs the response possibility indication process.

The processing management unit 120 uses the model 220, which has learned the relationship between the schedule setting 200 and the order information 330 as described above, to output the possibility of responding to a sudden order.

In other words, it presents the possibility of whether or not a job 230 can be allocated based on the state of the schedule setting 200 to the user by the GUI in the management terminal 6.

### (Step S104)

Then, the processing management unit 120 performs the allocation process.

If the user has examined the possibility of allocation and has instructed the allocation, the processing management unit 120 performs scheduling to allocate the job 230 to the available space in the schedule setting 200 by using the model 220.

In this case, the process management unit 120 acquires the characteristic data 300 for the unprocessed job 230 by analyzing the data of the job 230 itself or based on the user instruction. On this basis, the processing management unit 120 stores the size information 301, content information 302, and post-processing information 303 of the job 230 in the processing DB 210.

Then, the instruction information 360 for the unprocessed job 230 and the schedule setting 200 at the time of the instruction are input into the model 220 to obtain the output result. This output result indicates which component apparatus of the schedule setting 200 and which available space to allocate the unprocessed job 230 to.

Based on this allocation, the processing management unit 120 causes the corresponding component apparatus to process the unprocessed job 230. In other words, the processing management unit 120 performs scheduling to allocate the unprocessed job 230 to the free schedule (available space) in the schedule setting 200.

Alternatively, the processing management unit 120 may input each combination of unprocessed job 230 allocated to available spaces in the schedule setting 200 into the above-mentioned model 220. In such case, the process management unit 120 may score the processing results and processing performance, select an optimal combination of the unprocessed job 230 and the component apparatus, and perform scheduling based on it.

Here, when the processing management unit 120 allocates the job 230 to the scheduling setting 200, it may calculate the estimated time for the completion of processing for the job 230 and set it in the delivery date information 350. This estimated processing completion time may be calculated based on the processing capacity and status information of the component apparatuses in the schedule setting 200. For example, the processing management unit 120 may set the estimated processing completion time as the available space in the allocated schedule setting 200 and the expected processing time. Furthermore, the processing management unit 120 may calculate the estimated processing completion time for the relevant job 230 and set it to the job 230.

More specifically, the processing management unit 120 may calculate the processing time for each job 230 based on the number of pages to be printed for the job 230 and the average throughput (Page Per Minutes) of each component apparatus in the job 230. Furthermore, the processing management unit 120 may calculate other costs in addition to processing time, such as the amount of consumables, in the same way.

Furthermore, when allocating the job 230, the processing management unit 120 may present the job 230 itself as an error if the delivery date and time in the delivery date information 350 is exceeded.

The processing management unit 120 stores the scheduling output in the scheduling results of the processing DB 210.

At this point, the processing management unit 120 may send the scheduling results to the dedicated application in the management terminal 6.

The management terminal 6 can display the processing cost, processing time, amount of consumables, and other costs of the job 230 by the GUI of the dedicated application. In other words, on the GUI, the user can check the scheduling results of the job 230, and he or she can instruct the modification or selection of the model 220.

In addition, the processing management unit 120 may perform repeated scheduling by using the set values of the conditions set by the user. That means, repeated scheduling is performed, and if there is any free time, it is possible to optimally allocate the job 230.

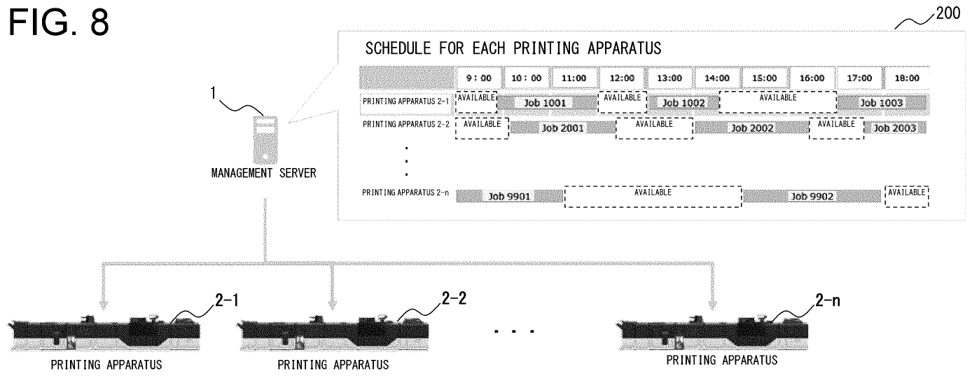

In FIG. 8, an example of allocating and executing the job 230 to the available space of the schedule setting 200 of the printing apparatus 2-1 to 2-n is shown.

This process starts the printing process, and the rasterization, printing, and post-processing of the job 230 is executed by the component apparatus set in the job 230. The processing management unit 120 may send the job 230 itself, processing status notification and completion notification of the job 230 to the management terminal 6 before and after the processing request and processing completion. In other words, the processing management unit 120 can manage the processing status and processing completion.

By the above, the job assignment process according to the embodiment of the present disclosure is completed.

As configured in this way, the following effects can be obtained.

In a typical production printing system, in order to efficiently process a large number of print jobs, the printing processing schedule for each component apparatus is created in advance for the order jobs of the following week or month, and printing operations are performed. The schedule is created based on the judgment of the creator based on their experience, so it is a task that is dependent on the person creating it, and it is not necessarily efficient.

In contrast, the industrial printing system X of the present embodiment is an industrial printing system that performs production printing, and includes a schedule management unit 100 that centrally manages the schedule setting 200 for processing jobs 230 of component apparatuses; a processing DB 210 that stores characteristic data 300 and processing result data 310 of processed jobs 230 and processing performance data 320 of component apparatuses; a learning unit 110 that trains a model 220 that optimally allocates jobs 230 to component apparatuses based on the characteristic data 300, processing result data 310, and processing performance data 320 stored in the processing DB 210; and a processing management unit 120 that allocates an unprocessed jobs 230 to available space in the schedule setting 200 based on the output result of the model 220 for the unprocessed job 230 according to instruction information 360 that includes conditions to be prioritized and causes the corresponding component apparatuses to process the unprocessed job 230.

In such configuration, with regard to the creation of schedules, which is a task that is currently conducted by human workers, the information required for scheduling can be used to train the AI model, and an optimal schedule can be generated by using AI. In other words, the creation of schedules, which is currently a task that is conducted by human workers, can be automated in a skill-free manner. Therefore, it is possible to create optimal schedules at any time from the data accumulated in the processing. Furthermore, it is possible to optimize the schedule at any time by training with the daily processing results. Therefore, it is possible to process the job 230, efficiently.

Furthermore, by using the instruction information 360, it is possible to generate an optimal schedule based on the condition to be prioritized.

In the industrial printing system X of the present embodiment, the processing result data 310 includes the delivery date achievement information 316, which includes the relationship between the forecast and the actual result in the scheduling for each characteristic of the job 230, the model 220 is a model that has also learned the delivery date achievement information 316, and the learning unit 110 also trains optimization of scheduling based on the instruction information 360 and the delivery date achievement information 316.

In such configuration, it is possible to perform optimal scheduling that takes into account deadlines. In other words, in a workflow system that manages multiple component apparatuses, it is possible to schedule jobs 230 that are processed optimally on time at each component apparatus.

In the industrial printing system X of the present embodiment, the processing DB 210 further stores order information 330 that indicates busy periods for orders and trends for sudden orders, and the learning unit 110 is also trains the relationship between the schedule setting 200 and the order information 330.

By configuring it in this way, it is possible to perform optimal scheduling according to the relationship between the schedule and the order.

In the industrial printing system X of the present embodiment, the processing management unit 120 also outputs possibility of handling sudden orders by using the model 220.

In this way, it is possible to present to the user the expected number of sudden orders, that is, how many sudden orders can be handled. This allows the user to set the available time of the component apparatus in preparation for the job 230 of the sudden order and schedule it.

In the industrial printing system X of the present embodiment, the characteristic data 300 of the job 230 includes size information 301, content information 302, and post-processing information 303, and the processing result data 310 includes output number information 311, processing result information 312, processing time information 313, and processing cost information 314, and processing performance data 320 includes processing capacity information 321, operating performance information 322, and color management information 323.

By configured in this way, the processing time from the contents of the job 230 and allocate the job 230 according to the processing capacity of the component apparatus can be estimated. It is also possible to perform scheduling by taking into account processing order of the job 230 to minimize set-changes of component apparatus, regular color management tasks to maintain color quality, and downtime due to errors or failures of component apparatus. Therefore, efficiently allocation of the job 230 can be performed.

In addition, efficient processing of the job 230 by taking into account the processing capacity and setting status of the component apparatus can be performed. It is also possible to minimize set changes such as changing the paper when printing. Thus, it is possible to streamline the printing process.

As a result, it is possible to perform processing more efficiently than with typical technology. In addition, it is possible to construct an autonomous and automated system in which the management server determines the processing status of the component apparatus and performs processing.

In the industrial printing system X of the present embodiment, the job 230 includes the delivery date information 350, and the processing management unit 120 performs scheduling based on the conditions of whether to prioritize the delivery date information 350 or the cost, and the threshold of the completion processing time of the job 230.

By configuring it in this way, based on the delivery date or cost set in the job 230 itself, processing can be performed. In addition, by scheduling based on the completion threshold of the set job 230, the job 230 can be allocated to the component apparatus, appropriately, and process it in accordance with the user's intention.

### Other Embodiments

In the above-mentioned embodiment, it is described that a job 230 is generated by the management server 1 of a workflow system and the job 230 is allocated to a component apparatus connected with the management server.

However, it may be a system that connects multiple management servers 1 in a peer-to-peer manner. In such case, the jobs 230 can be allocated to component apparatuses of management servers 1 at different locations. Thus, the processing management unit 120 is able to transfer jobs 230 to be processed by component apparatuses connected to management servers 1 different from its own management server 1 to the different management server 1.

Alternatively, a management server 1 that represents processing for each job 230 may be set. In this way, a job 230 that has been sent to the management server 1 that represents for each job 230 may be transferred from the representative management server 1 to a management server 1 at a different location.

Due to this configuration, in the model 220, the component apparatuses of the management server 1 at a different location may be set.

Alternatively, it may be configured so that jobs 230 are allocated flexibly between DFE of component apparatuses in a peer-to-peer manner without using management server 1. In this case, for example, a representative printing apparatus 2 may be set in place of representative management server 1 for the job 230, and the representative printing apparatus 2 may perform similar processing as DFE. Furthermore, it may be possible to transfer the job 230 between component apparatuses.

In this way, the management servers 1 can be linked together in a peer-to-peer manner, and the jobs 230 can be allocated even to component apparatuses located at different sites. In other words, jobs 230 can be optimally distributed and processed. Therefore, it is possible to easily link existing company sites, and the like, to improve the efficiency of execution of the job 230. In other words, it is possible to improve the efficiency of the entire printing process by linking multiple printing lines.

In the above-mentioned embodiment, the example is described that learning and allocation of unprocessed jobs 230 are performed, sequentially. However, it is also possible to handle the learning process as a separate process, such as just learning and then using the learned model 220 to allocate jobs 230. In such case, it is also possible to use separate management servers or servers dedicated to learning and allocation. It is also possible to configure the system so that only learning is performed on a cloud server.

Also, in the above-mentioned embodiment, the example described that the allocation of unprocessed jobs 230 is started sequentially according to the user's instruction.

However, the processing management unit 120 may start scheduling when the set time, set interval, or number of acquired jobs 230 reaches the set value of the condition.

By configuring in this way, learning and the allocation of jobs 230 can be optimized. In addition, it is possible to start scheduling according to any conditions set by the user.

Therefore, learning and scheduling can be performed at the appropriate time in the user's environment, and this is to be ultimately lead to efficient processing of job 230.

Also, the job 230 may include instruction information 360 indicating whether delivery date or cost is to be prioritized, and the processing management unit 120 may perform scheduling based on the instruction information 360 of job 230.

By configuring in this way, scheduling can be performed based on the instruction information 360 set in the job 230 itself. This allows efficient scheduling to be performed by combining the user's instruction and the instruction information 360 of the job 230 itself.

In the above-mentioned embodiment, an example described is one in which the rasterization processing, printing processing, and post-processing of the job 230 are combined into a single job 230 without distinguishing between them. However, it is also possible to set up separate models 220 for rasterization, printing, and post-processing, and combine them into a single job 230.

By configuring in this way, it is possible to flexibly combine jobs 230 according to the type and number of component apparatuses for each process.

In the above-mentioned embodiment, an example of executing a job 230 as is described.

However, the job 230 itself may be changed in response to status notifications, completion notifications, error notifications, or the like, for the job 230.

In this case, it is also possible to change the job 230 in response to processing change information or alternative settings. That is, when a processing request is adjusted due to a delay, or the like, the job may be changed to a processable job 230. For example, it is possible to change the number of pages, the color profile to be used, and the like, depending on the alternative setting.

Also, in the above-mentioned embodiment, an example is described that each job 230 is allocated to a free component apparatus of the schedule setting 200.

However, if there is not enough time to allocate the job 230 to the free component apparatus, or if the number of pages or copies included in the job 230 is large, it is also possible to divide the job 230 itself and allocate it to another free component apparatus. Furthermore, it is also possible to configure the divided job 230 can be allocated to the available space of each of the multiple component apparatuses.

By configured in this way, it is possible to perform flexible processing.

In addition, in the terminology used in the present specification, the singular forms “a,” “an,” and “the” also include the plural forms unless the context clearly indicates otherwise.

It goes without saying that the configuration and operation of the above-mentioned embodiments are examples, and that they can be changed and executed as appropriate within the scope of not deviating from the aim of the present disclosure.

What is claimed is:

1. An industrial printing system for production printing having component apparatuses and a management server that manages jobs for the component apparatuses, comprising:
a schedule management unit configured to centrally manage the schedule setting for processing jobs of the component apparatuses;
a processing database configured to store characteristic data and processing result data of the processed jobs and processing performance data of the component apparatuses;
a learning unit configured to train a model for optimally allocating the jobs to the component apparatuses based on the characteristic data, the processing result data, and the processing performance data stored in the processing database; and
a processing management unit configured to allocate an unprocessed job to the available space in the schedule setting based on an output result of the model for the unprocessed job in accordance with instruction information having a condition to be prioritized and cause corresponding component apparatus to process the unprocessed job.

2. The industrial printing system according to claim 1, wherein
the processing result data includes delivery date achievement information, which includes relationship between forecast and actual result in scheduling for each characteristic of the jobs,
the model is a model that has also learned the delivery date achievement information, and
the learning unit also trains optimization of scheduling based on the instruction information and the delivery date achievement information.

3. The industrial printing system according to claim 2, wherein
the processing database further stores order information indicating a busy period for orders and trends in sudden orders, and
the learning unit also trains the relationship between the schedule setting and the order information.

4. The industrial printing system according to claim 3, wherein
the processing management unit also outputs possibility of handling sudden orders by using the model.

5. The industrial printing system according to claim 1, wherein
the characteristic data of the job includes size information, content information, and post-processing information,
the processing result data includes output number information, processing result information, processing time information, and processing cost information, and
the processing performance data includes processing capacity information, operating performance information, and color management information.

6. A management server that manages jobs for component apparatuses in an industrial printing system for production printing, comprising:
a schedule management unit configured to centrally manage the schedule setting for processing jobs of component apparatuses;
a processing database configured to store characteristic data and processing result data of the processed jobs and processing performance data of the component apparatuses;
a learning unit configured to train a model for optimally allocating the jobs to the component apparatuses based on the characteristic data, the processing result data, and the processing performance data stored in the processing database; and
a processing management unit configured to allocate an unprocessed job to the available space in the schedule setting based on an output result of the model for the unprocessed job in accordance with instruction information having a condition to be prioritized and cause corresponding component apparatus to process the unprocessed job.

7. The management server according to claim 6, wherein
the processing result data includes delivery date achievement information, which includes relationship between forecast and actual result in scheduling for each characteristic of the jobs,
the model is a model that has also learned the delivery date achievement information, and
the learning unit also trains optimization of scheduling based on the instruction information and the delivery date achievement information.

8. The management server according to claim 7, wherein
the processing database further stores order information indicating a busy period for orders and trends in sudden orders, and
the learning unit also trains the relationship between the schedule setting and the order information.

9. The management server according to claim 8, wherein
the processing management unit also outputs possibility of handling sudden orders by using the model.

10. The management server according to claim 6, wherein
the characteristic data of the job includes size information, content information, and post-processing information,
the processing result data includes output number information, processing result information, processing time information, and processing cost information, and
the processing performance data includes processing capacity information, operating performance information, and color management information.

11. A processing management method executed by a management server that manages jobs of component apparatuses in an industrial printing system for performing production printing, comprising the steps of:
centrally managing the schedule setting for processing jobs of the component apparatuses;
storing characteristic data and processing result data of the processed jobs and processing performance data of the component apparatuses;
training a model for optimally allocating the jobs to the component apparatuses based on the characteristic data, the processing result data, and the processing performance data that are stored;
allocating an unprocessed job to the available space in the schedule setting based on an output result of the model for the unprocessed job in accordance with instruction information having a condition to be prioritized; and
causing corresponding component apparatus to process the unprocessed job.

12. The processing management method according to claim 11, wherein
the processing result data includes delivery date achievement information, which includes relationship between forecast and actual result in scheduling for each characteristic of the jobs,
the model is a model that has also learned the delivery date achievement information, and further comprising a step of:
training optimization of scheduling based on the instruction information and the delivery date achievement information.

13. The processing management method according to claim 12, wherein
the processing database further stores order information indicating a busy period for orders and trends in sudden orders, and further comprising a step of:
training the relationship between the schedule setting and the order information.

14. The processing management method according to claim 13, further comprising a step of:
outputting possibility of handling sudden orders by using the model.

15. The processing management method according to claim 14, wherein
the characteristic data of the job includes size information, content information, and post-processing information,
the processing result data includes output number information, processing result information, processing time information, and processing cost information, and
the processing performance data includes processing capacity information, operating performance information, and color management information.
